(19) United States
(12) Patent Application Publication
(10) Pub. No.: US 2004/0223108 A1
(43) Pub. Date: Nov. 11, 2004

(54) Liquid crystal display device and method of manufacturing the same

(76) Inventors: Tsau Hua Hsieh, Miao-Li (TW); Jia-Pang Pang, Miao-Li (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/843,401

(22) Filed: May 10, 2004

(30) Foreign Application Priority Data
May 9, 2003 (TW) 92112728

(51) Int. Cl. G02F 1/1339

(52) U.S. Cl. 349/153

(57) ABSTRACT

A liquid crystal display device (300) includes a first substrate (35), a color filter (38) having a black frame (39), a sealing member (34) and a second substrate (33). The first substrate combines with the second substrate to form a cavity. The color filter is attached on an inner surface of the first substrate. The black frame has a patterned design and is arranged along an outer periphery of the color filter. The sealing member is formed on an area of the black frame, located on the black frame. The sealing member attaches the first and the second substrates together.

### BACKGROUND OF THE INVENTION

1. Field of the Invention

The invention generally relates to a liquid crystal display (LCD) device and a method of manufacturing the same.

2. The Related Art

In general, an LCD device has the advantages of thinness, light weight, and low power consumption. For that reason, LCD devices are widely used in various types of electronic equipment, from pocket calculators to large-scale office automation equipment.

The basic structure of an LCD device is shown in FIG. 8. The LCD device 100 comprises a thin layer of liquid crystal 12 retained between two substrates 13, 15 attached together by a sealing member 14. A TFT (Thin Film Transistor) layer 11 is formed on an inner surface of the substrate 13. The substrate 15 opposite to the substrate 13 has a color filter 18 matching with the TFT layer 11. The color filter 18 includes a black matrix 181 for shielding light and color layers 182 alternately positioned within the black matrix 181. A plurality of wires 17 extend from the TFT layer 11 and through the sealing member 14, which are electrically connected with a driving circuit (not labeled).

The black matrix has a wide black frame 19 integrally formed therewith, for improving brightness contrast. The black frame 19 surrounds the color layers 182 and is disposed between the color layers 182 and the sealing member 14.

In manufacture of an LCD device, the most generally used method of filling the liquid crystal into the cavity formed between the two substrates 13, 15 is the vacuum insertion method. However, the method has various disadvantages, such as the lengthy period of time required to complete the process of filling the cavity with the liquid crystal.

For that reason, another method of filling the cavity, the so-called “One Drop Fill” (ODF) method was recently published. However, the problem with the LCD device 100 manufactured by this ODF method is that the sealing member 14 adhering to the substrate 15 and separated from the black frame 19 makes an area of the LCD device 100 unnecessarily large. The cause of the problem will be described in detail.

In manufacture of the LCD device 100 using the ODF method, the liquid crystal is dropped onto either one of the two substrates 13, 15 within the bounds described by the sealing member 14, which is formed on a peripheral region of the substrate. At this stage the sealing member 14 is not polymerized. The conventional heat-treatment method of hardening or polymerizing the sealing member 14 is generally not applicable since high temperatures would be detrimental to the liquid crystal between the two substrates 13, 15. Instead of thermal curing, the sealing member 14 is polymerized and hardened by photo-curing using ultraviolet (UV) radiation irradiating through other of the two substrates 13, 15.

Experience has shown that any uncured or partially cured sealing member 14 can cause serious contamination of the liquid crystal and can lead to a long term degradation of the LCD device 100. So, to fully harden the sealing member 14 using photo-curing, the sealing member 14 has to be separated from the black frame 19 on the inner surface of the substrate 15 to allow enough UV light radiation to transmit through the second substrate 15 to photo-cure the sealing member 14. Thus, an area of the LCD device 100 is larger than it otherwise would be.

Therefore, an LCD device with a more efficient area utilization is desired.

### SUMMARY OF THE INVENTION

An object of the present invention is to provide a liquid crystal display device having a high brightness contrast and a more efficient area utilization.

Another object of the present invention is to provide a method of manufacturing the above-described liquid crystal display device.

A liquid crystal display device includes a first substrate, a color filter having a black frame, a sealing member, and a second substrate. The first substrate combines with the second substrate to form a cavity. The color filter is attached on an inner surface of the first substrate. The black frame has a patterned design and is arranged along an outer periphery of the color filter. The sealing member is deposited on the area of the black frame, over the black frame, and the sealing member attaches the first and the second substrates together.

A method of manufacturing a liquid crystal display device comprises the steps of preparing a first substrate and a second substrate; forming a black matrix on the first substrate, the black matrix having a patterned black frame around a periphery thereof; forming a sealing member with a closed periphery on the black frame; dropping liquid crystal on an area of the first substrate within the bounds of the sealing member; placing the second substrate on the sealing member and aligning the first substrate and the second substrate; and curing the sealing member using light shining through the first substrate to cure the sealing member.

Other objects, advantages, and novel features of the present invention will become more apparent from the following detailed description when taken in conjunction with the accompanying drawings.

### BRIEF DESCRIPTION OF THE DRAWINGS

FIG. 1 is a cross-sectional view of an LCD device according to the present invention;

FIG. 2 is a cross-sectional view taken along the line of 2-2 in FIG. 1;

FIG. 3 is a cross-sectional view taken along the line of 3-3 in FIG. 1;

FIG. 4 is an essential optical paths diagram of light being blocked in the LCD device in FIG. 3;

FIG. 5 is a flow chart of manufacturing the first embodiment of LCD device in FIG. 1 according to the present invention;

FIG. 6 is an essential optical paths diagram of exposing a sealing member of the LCD device in FIG. 3;

FIG. 7 is a second embodiment of an LCD device according to the present invention; and

FIG. 8 is a cross-sectional view of a prior art LCD device.

### DESCRIPTION OF THE PREFERRED EMBODIMENTS

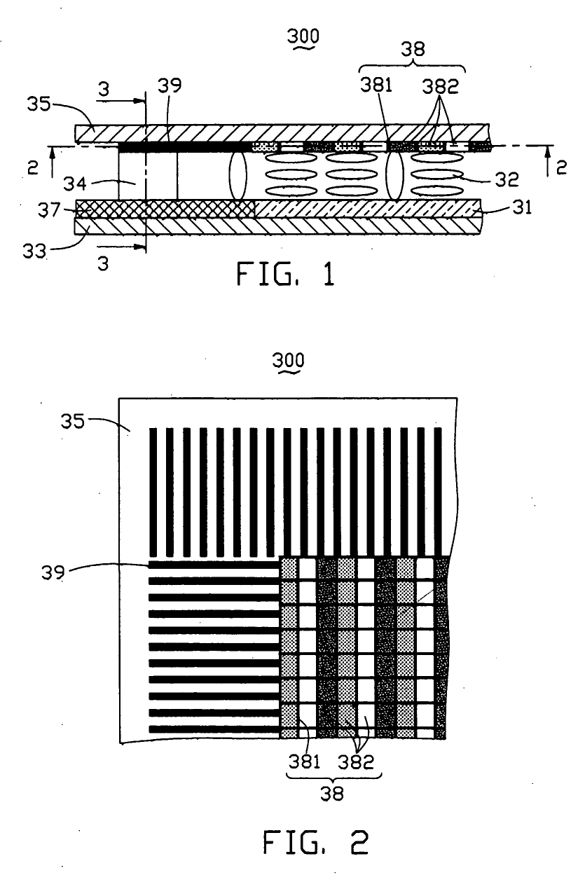

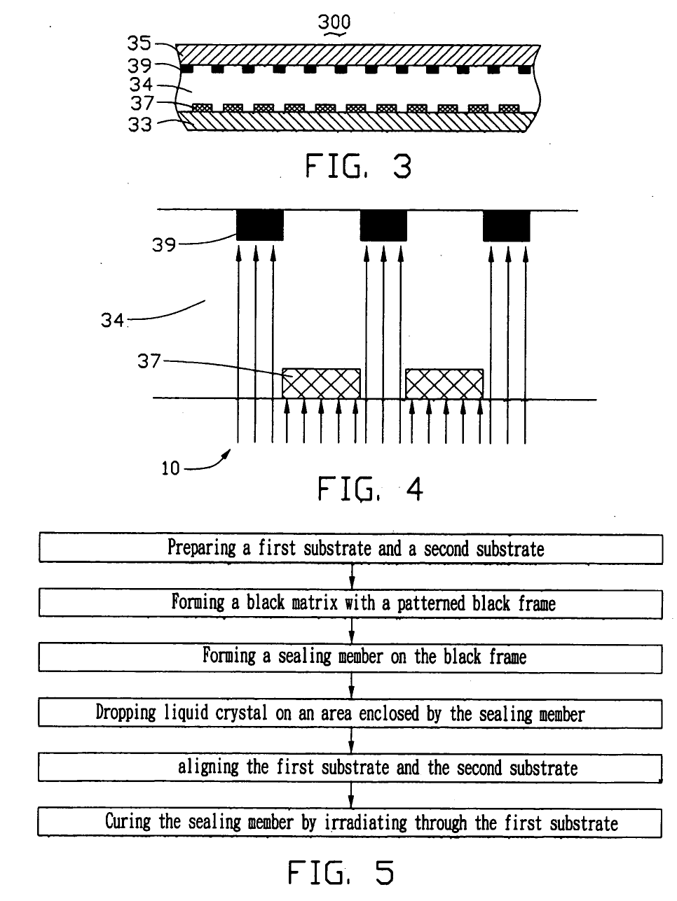

Referring to FIGS. 1-3, a first embodiment of an LCD device 300 includes a first substrate 35, a sealing member 34, and a second substrate 33. The two substrates 33, 35 are positioned parallel and opposite to each other. A liquid crystal layer 32 is retained between the two substrates 33, 35. A color filter 38 and a TFT layer 31 are located on the two inner surfaces of the two substrates 35, 33 respectively. The TFT layer 31 is opposite to and aligned with the color filter 38.

The color filter 38 includes a black matrix 381 for shielding light beams impinging thereon and three primarily color layers (R.B.G) 382 located in spaces of the black matrix 381. Further more, the color filter 38 also includes a black frame 39 which is an outer periphery of the black matrix 381. The black frame 39 has a comb-like construction including a plurality of teeth. A width of each tooth of the black frame 39 is wider than a width of each strip making up the majority of the black matrix 381. The wide teeth improve the brightness contrast of the LCD device 300. A plurality of wires 37 extends from the edges of the TFT layer 31 and covers a remainder of the inner surface of the second substrate 33, and passes through the sealing member 34. The wires 37 are arranged in a comb-like pattern complementary to the plurality of teeth. In other words, the teeth of the wires 37 are positioned in an alternating sequence with the teeth of the black frame 39, between and juxtaposed with the teeth, but in a different parallel plane from the teeth of the black frame 39.

The sealing member 34 is located underneath the black frame 39 formed on an inner surface of the first substrate 35. The sealing member 34 is made of a photosensitive resin or a mixture of photosensitive and thermosensitive resin.

Other embodiments of the LCD device may feature the black frame 39 being made of a pattern of squares, or a cross-section of the teeth of the black frame 39 having a shape of a parallelogram (see FIG. 7).

The advantage of the LCD device 300 is that it utilizes the area occupied more efficiently since the sealing member 34 is located underneath the black frame 39.

Referring to FIG. 4, when in use with a back light, light can not pass through the black frame 39 and the wires 37 since the wires 37 and teeth of the comb-like black frame 39 are in alternating masking relation to one another. So the LCD device 300 retains a good brightness contrast and performance.

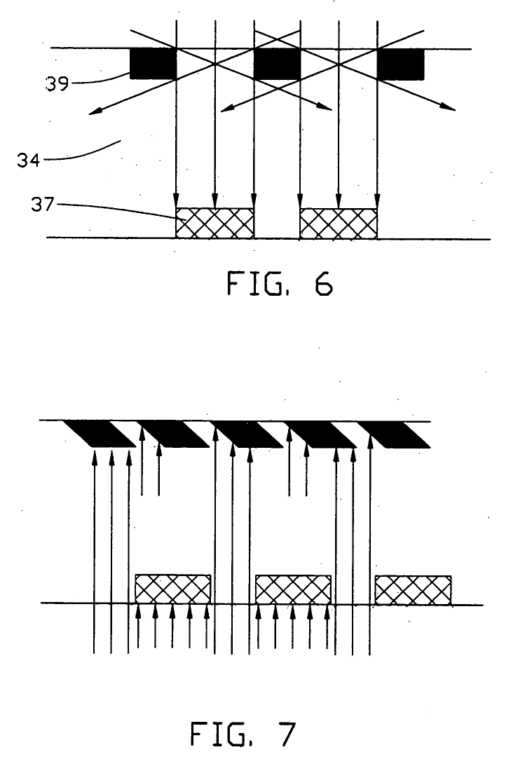

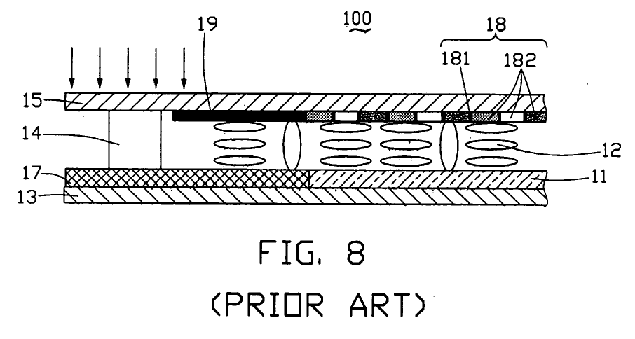

Referring also to FIG. 5, a first embodiment of a method of manufacturing the LCD device 300 includes: preparing a first substrate 35 and a second substrate 33; attaching a TFT layer 31 on the surface of the second substrate 33; forming a plurality of wires 37 electrically and mechanically connecting to edges of the TFT layer 31 and extending on the surface of the second substrate 33; forming the black matrix 381 on the first substrate 35, the black matrix 381 having a patterned black frame 39 around a periphery thereof; filling the three primarily color layers (R.B.G) 382 into the spaces of the black matrix 381; forming a sealing member 34 with a closed periphery on the black frame 39; dropping liquid crystal on an area of the first substrate 35 within the bounds of the sealing member 34; placing the second substrate 33 on the sealing member 34 and aligning the first substrate 35 and the second substrate 33; and curing the sealing member 34 by shining a light through the first substrate 35 to cure the sealing member 34. In the process of curing the sealing member 34, the radiative light illuminates the sealing member 34 through spaces of the patterned black frame 39 in variable directions (see FIG. 6.)

The black frame 39 of the black matrix 381 is fabricated by a photolithography process. The steps in manufacturing the black frame 39 according to a first embodiment include: forming a photosensitive layer on the surface of the first substrate 35, curing the photosensitive layer, and developing it later to form the black matrix 381 with the black frame 39.

The steps in manufacturing the black frame 39 according to a second embodiment include: forming a photosensitive layer on the surface of the first substrate 35; exposing the center part of the photosensitive layer through the first substrate 35 to form the center part of the black matrix 381; aligning the first substrate 35 and the second substrate 33; exposing the remainder part of the photosensitive resin layer through the second substrate 33 using the wires 37 of the second substrate 33 as a photo mask to form the black frame 39 of the black matrix 381; developing the photosensitive layer to form the black frame 39.

Referring to FIG. 6, light beams can illuminate the first substrate 35 from perpendicular or oblique directions. When the light is from an oblique direction, it can illuminate parts of the sealing member 34 beneath the teeth of the black frame 39. So that the sealing member 34 can be fully hardened, allowing the LCD device 300 to attain high performance.

Since the exposing step for fabricating the black frame 39 according to the second embodiment utilizes the wires 37 on the second substrate 33 as a photo mask, the wires 37 and the black frame 39 are in alternating masking relation, thus attain a light blocking capability.

A third embodiment replaces the photosensitive layer mentioned above with a metal shielding layer that can be etched. The steps in manufacturing the black frame 39 and black matrix 381 include forming a metal shielding layer on the surface of the first substrate 35; forming a photoresistive layer on the metal shielding layer; curing and developing the photoresistive layer; and etching the metal shielding layer; thus forming the black matrix 381 with the black frame 39.

Advantages of the described embodiments over the prior art include the following. First, the LCD device 300 can utilize the area occupied more efficiently, so can be made smaller. Second, the black frame 39 and the wires 37 can entirely shield the periphery of the back light, thus the LCD device 300 retains a high performance.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A liquid crystal display device comprising:
a first substrate;
a color filter having a black frame and being formed on an inner surface of the first substrate;
a sealing member; and
a second substrate;
wherein the first substrate combines with the second substrate to form a cavity, the black frame has a patterned design and is arranged along an outer periphery of the color filter, the sealing member is deposited on the area of the black frame, over the black frame, and the sealing member attaches the first and the second substrates together.

2. The liquid crystal display device as claimed in claim 1, wherein the color filter includes a black matrix.

3. The liquid crystal display device as claimed in claim 2, wherein the black frame is an outer periphery of the black matrix.

4. The liquid crystal display device as claimed in claim 1, wherein the sealing member is made of a photosensitive resin or a mixture of photosensitive and thermosensitive resin.

5. The liquid crystal display device as claimed in claim 1, wherein the liquid crystal display device includes a TFT layer attached on the inner surface of the second substrate, opposite to and aligned with the color filter, and a plurality of wires extend from the TFT layer and under the sealing member.

6. The liquid crystal display device as claimed in claim 5, wherein the black frame has a comb-like construction comprising a plurality of teeth, and the wires are positioned in an alternating sequence with the teeth, between and juxtaposed with the teeth, but in a different parallel plane from the teeth.

7. The liquid crystal display device as claimed in claim 1, wherein the black frame has a comb-like construction comprising a plurality of teeth, and each tooth has a parallelogram-shaped cross-section.

8. A method of manufacturing a liquid crystal display device comprising the steps of:
Preparing a first substrate and a second substrate;
Forming a black matrix on the first substrate, the black matrix having a patterned black frame around a periphery thereof;
Forming a sealing member with a closed periphery on the black frame;
Dropping liquid crystal on an area of the first substrate within the bounds of the sealing member;
Placing the second substrate on the sealing member and aligning the first substrate and the second substrate; and
Curing the sealing member by shining light through the first substrate to cure the sealing member.

9. The method of manufacturing a liquid crystal display device as claimed in claim 8, wherein the light illuminates the sealing member through spaces of the patterned black frame in variable directions.

10. The method of manufacturing a liquid crystal display device as claimed in claim 8, wherein the method further comprises the steps of attaching a TFT layer on a surface of the second substrate, along with a plurality of wires electrically and mechanically connecting to edges of the TFT layer, the wires extending on the surface of the second substrate; forming a photosensitive resin layer on the first substrate; then curing and developing the photosensitive resin layer to form the black matrix after preparing the first substrate and the second substrate.

11. The method of manufacturing a liquid crystal display device as claimed in claim 10, wherein the step of curing the photosensitive resin layer to form the black matrix utilizes a photo mask.

12. The method of manufacturing a liquid crystal display device as claimed in claim 10, wherein the step of curing the photosensitive resin layer for forming the black matrix is completed by the steps of exposing the center part of the photosensitive resin layer through the first substrate to form the center part of the black matrix; aligning the first substrate and the second substrate; and exposing the remainder part of the photosensitive resin layer through the first substrate using the wires of the second substrate as a photo mask to form the black frame of the black matrix.

13. The method of manufacturing a liquid crystal display device as claimed in claim 8, wherein the second step is completed by forming a metal shielding layer on a surface of the first substrate; forming a photoresistive layer on the metal shielding layer; curing and developing the photoresistive layer, and etching the metal shielding layer.

14. The liquid crystal display as claimed in claim 1, wherein the sealing member is under the black frame vertically.
